(19) United States
(12) Patent Application Publication
(10) Pub. No.: US 2018/0204166 A1
(43) Pub. Date: Jul. 19, 2018

(54) MANUFACTURING LINE GAMIFICATION SYSTEM FOR EMPLOYEES SELF-MANAGEMENT AND METHOD THEREOF

(71) Applicant: Visual-Factories, Tel Aviv (IL)

(72) Inventor: Matitiahu TIANO, Tel Aviv (IL)

(21) Appl. No.: 15/742,750

(22) PCT Filed: Jun. 7, 2016
(86) PCT No.: PCT/IL2016/050584

§ 371 Date: Jan. 8, 2018

Related U.S. Application Data
(60) Provisional application No. 62/188,761, filed on Jul. 6, 2015.

(51) Int. Cl. G06Q 10/06; G09B 19/00; G09B 19/18

(52) U.S. Cl. CPC G06Q 10/063114; G09B 19/18; G09B 19/003; G06Q 10/0639

(57) ABSTRACT

A computer-implemented gamification system and method to provide one or more gamification platforms to one or more users in an manufacturing line, said gamification system comprising: a server including a processor, memory and computer readable media; an application module communicably coupled to said server, configured to provide a unified and an integrated gamification functions in real time across one or more manufacturing line applications; an end user module communicably coupled to said server, wherein said module comprises gamification data that an end user provides to or receives through a user interface; a database layer communicably coupled to said server, and configured to manage and manipulate data in underlying database; and said application module further comprises: a tracker engine configured to track one or more activities associated with manufacturing line performance of said one or more end users and communicate said one or more activities accomplished by said one or more users to a rule engine; and said rule engine configured to define one or more unified parameters to correlate to said one or more activities across said one or more manufacturing line applications by said one or more users; and a generating engine configured to generate gamification system framework comprising said unified parameters correlating to said one or more activities across said one or more manufacturing line applications of said one or more users. A method in support of providing one or more gamification platforms to one or more users in an manufacturing line, performed by a server, the server being connected to a network and having a memory, a processor, and one or more code sets stored in the memory and executable in the processor, said method comprising: providing a unified and an integrated gamification functions in real time across one or more manufacturing line applications; managing and manipulating data in underlying database; tracking one or more activities associated with manufacturing line performance of one or more end users and communicating said one or more activities accomplished by said one or more users; defining one or more unified parameters to correlate to said one or more activities across said one or more manufacturing line applications by said one or more users; and generating gamification system framework comprising said unified parameters correlating to said one or more activities across said one or more manufacturing line applications of said one or more users.

### FIELD OF THE INVENTION

The present invention relates generally to manufacturing line gamification system and method for employees self-management that increase end user productivity, engagement, motivation, and reinforce learning.

### BACKGROUND OF THE INVENTION

By taking elements of game mechanics (goals, rules, feedback) and carefully applying them in the workplace, companies (and their employees) realize benefits including motivating players to achieve higher levels of productivity and fostering stronger social connections amongst game participants—both of which are good for businesses. One of the business applications referring to applications that are used in the performance of everyday or routine work for an enterprise is, for example, manufacturing line gamification application where the competence in using the application is required for job performance and greater proficiency in such application translate into increased productivity. The growing demand for highly individualized and complicated products promotes the return, the necessity and the importance of human work in production. Particularly for supply chain or manufacturing businesses, game elements and competitions can be introduced into the production processes in order to motivate performance. Many businesses already do this as part of their day-to-day operations.

However, current computer-based assistive systems in production focus the control of work results rather than the support of the worker. If there is support, it focuses on describing the upcoming steps in the work process, often combined with images or animations on how to place or assemble a specific part.

US Patent Publication No. 2013/0324201, published on Dec. 5, 2013, discloses methods, systems, and apparatus, including computer programs encoded on a computer storage medium for applying gamification techniques to process incidents. A gamification environment to process service incidents received at a service management computer system is developed based on skills of service incident processors who process service incidents and a respective level for each incident processor's skill. The gamification environment is provided to process service incidents received at the service management computer system from, for example, a customer organization. When a service incident is received, tasks to be performed to resolve the incident and one or more service incident processors who possess the skill at the level to perform the tasks are identified. The service incident is identified to the identified processors who resolve the incident. Once resolved, one or more of the identified incident processors are assigned a credit determined based on the service incident.

US Patent Publication No. 2013/0337909, published on Dec. 19, 2013, by Laurie Pattison et al., discloses an approach that can be used to create gamification for any application/activity. In some approaches, gamification is provided such that an application is not modified to include the game features. Instead, an external stand-alone gamification mechanism is provided to include the game features, where the external gamification mechanism is used in conjunction with the activity/application.

US Patent Publication No. 8768751, published on Jul. 1, 2014, discloses methods, computer-readable media, and systems for gathering gamification data from business applications. Common gamification data that describes a user that accesses a business software environment, and specific gamification data that describes the user and is specific to a particular computer system in the business environment are identified at a user interface of a client device in response to a request from a gamification engine. By executing gamification logic in the user interface, the common gamification data and the specific gamification data are collected at the user interface and provided to the gamification engine. For example, the gamification data can be gathered by monitoring interactions between the user and the client device that is connected to the gamification engine at the user interface, and provided to the gamification engine independent of the business computer system to which the client device is connected.

Therefore, there is a long felt and unmet need for a system and method that overcomes the problems associated with the prior art. The system and method will provide one or more gamification platforms to one or more users in a manufacturing line to increase end user self-management productivity, engagement, motivation, and reinforce learning.

### SUMMARY

It is hence one object of this invention to disclose a computer-implemented gamification system to provide one or more gamification platforms to one or more users in an manufacturing line, said gamification system comprising: a server including a processor, memory and computer readable media; an application module communicably coupled to said server, configured to provide a unified and an integrated gamification functions in real time across one or more manufacturing line applications; an end user module communicably coupled to said server, wherein said module comprises gamification data that an end user provides to or receives through a user interface; a database layer communicably coupled to said server, and configured to manage and manipulate data in underlying database; and said application module further comprises: a tracker engine configured to track one or more activities associated with manufacturing line performance of said one or more end users and communicate said one or more activities accomplished by said one or more users to a rule engine; and said rule engine configured to define one or more unified parameters to correlate to said one or more activities across said one or more manufacturing line applications by said one or more users; and a generating engine configured to generate gamification system framework comprising said unified parameters correlating to said one or more activities across said one or more manufacturing line applications of said one or more users.

It is another object of the current invention to disclose a computer-implemented gamification system to provide one or more gamification platforms to one or more users in an manufacturing line, said gamification system comprising: means for providing a unified and an integrated gamification functions in real time across one or more manufacturing line applications; means for managing and manipulating data in underlying database; means for tracking one or more activities associated with manufacturing line performance of one or more end users and communicating said one or more activities accomplished by said one or more users; means for defining one or more unified parameters to correlate to said one or more activities across said one or more manufacturing line applications by said one or more users; and means for generating gamification system framework comprising said unified parameters correlating to said one or more activities across said one or more manufacturing line applications of said one or more users.

It is another object of the current invention to disclose a computer readable medium comprising a computer-implemented gamification system, said system comprises logic for: providing a unified and an integrated gamification functions in real time across one or more manufacturing line applications; managing and manipulating data in underlying database; tracking one or more activities associated with manufacturing line performance of one or more end users and communicating said one or more activities accomplished by said one or more users; defining one or more unified parameters to correlate to said one or more activities across said one or more manufacturing line applications by said one or more users; and generating gamification system framework comprising said unified parameters correlating to said one or more activities across said one or more manufacturing line applications of said one or more users.

It is another object of the current invention to disclose a method in support of providing one or more gamification platforms to one or more users in an manufacturing line, performed by a server, the server being connected to a network and having a memory, a processor, and one or more code sets stored in the memory and executable in the processor, said method comprising: providing a unified and an integrated gamification functions in real time across one or more manufacturing line applications; managing and manipulating data in underlying database; tracking one or more activities associated with manufacturing line performance of one or more end users and communicating said one or more activities accomplished by said one or more users; defining one or more unified parameters to correlate to said one or more activities across said one or more manufacturing line applications by said one or more users; and generating gamification system framework comprising said unified parameters correlating to said one or more activities across said one or more manufacturing line applications of said one or more users.

### BRIEF DESCRIPTION OF THE FIGURES

In the following detailed description of the preferred embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 schematically presents a block diagram of one embodiment of a system of the present invention;

FIG. 2 is a flow diagram illustrating a method to provide one or more gamification platforms to one or more users in a manufacturing line.

FIG. 3 presents the variety of systems that can be integrated and used as a source or as a client of gamification platforms to one or more users in a manufacturing line such as: tool-management, adaptive control monitor, maintenance management, manufacturing execution system and quality management.

FIG. 4 presents a diagram describing the components of the storage means.

FIG. 5 presents a diagram describing the system's output element displayed via the display means.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving,” “changing, “code” “capturing,” “preparing,” “correlating,” “displaying,” “classifying”, “configuring” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices, including integrated circuits down to and including chip level firmware, assembler, and hardware based micro code.

The term “computer readable medium” interchangeably refers hereinafter to any memory that can be accessed and interfaced with by a machine (e.g. computer) including, but not limited to, high-speed random access memory and may also include non-volatile memory, such as one or more magnetic disk storage devices, flash memory devices, or other non-volatile solid-state memory devices, a direct-access data storage media such as hard disks, CD-RWs and DVD-RW can also be used to store software components and/or image databases.

The term “device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands.

The term “display screen” interchangeably refers hereinafter to any regular/touch-sensitive surface, known in the art. The user can navigate between the graphical outputs presented on the screen, and interact with presented digital navigation. Additionally or alternatively, the present application can be connected to a user interface detecting input from a keyboard, a button, a click wheel, a touchpad, a roller, a computer mouse, a motion detector, sound detector, speech detector, joystick, and etc., for activating or deactivating particular functions. A user can navigate among and interact with one or more graphical user interface objects that represent at least visual navigation content, displayed on screen. In some embodiments the interaction is by means such as computer mouse, motion sensor, means of a touch screen, keyboard, voice activation, joystick, electronic pad and pen, touch sensitive pad, a designated set of buttons, soft keys, and the like.

The term “platform”, as used herein, includes but is not limited to a computing system that combines hardware and software, including application frameworks. The platform may include a computer architecture, operating system, programming languages, and related user interfaces, including run-time system libraries and/or graphical user interfaces. Providing a “platform as a service” (PaaS) is a category of computing services that may provide an integrated platform with specific application solutions as a service, with various levels of scalability. Services may include providing specialized and/or customized hardware, such as, for example, networks, servers, storage, interface devices, etc., and software, such as, for example, applications, interfaces, security, etc. Hardware and/or software associated with the services may or may not be dedicated to one platform. Providing a PaaS may include development, testing, deployment, hosting, maintenance, updating, etc. A PaaS may include the capability to integrate with various outside and/or private systems, such as, for example, web services, databases, and networks, utilizing, for example, Simple Object Access Protocol (SOAP) and Representational State Transfer (REST) interfaces.

The term “storage/memory” refers hereinafter to any collection, set, assortment, cluster, selection and/or combination of content stored digitally.

The term “software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

The term “work-piece”, as used herein, refers to any object, device, or the like, which is shaped, heated, or otherwise worked on by a tool or machine during manufacturing, and not simply raw material. For instance, a metal being worked on via induction heating or abrasive cutting. The workpiece may have been also partially finished, thus including machining course of action, loading idle time, resulted quality, wear characteristic features and others.

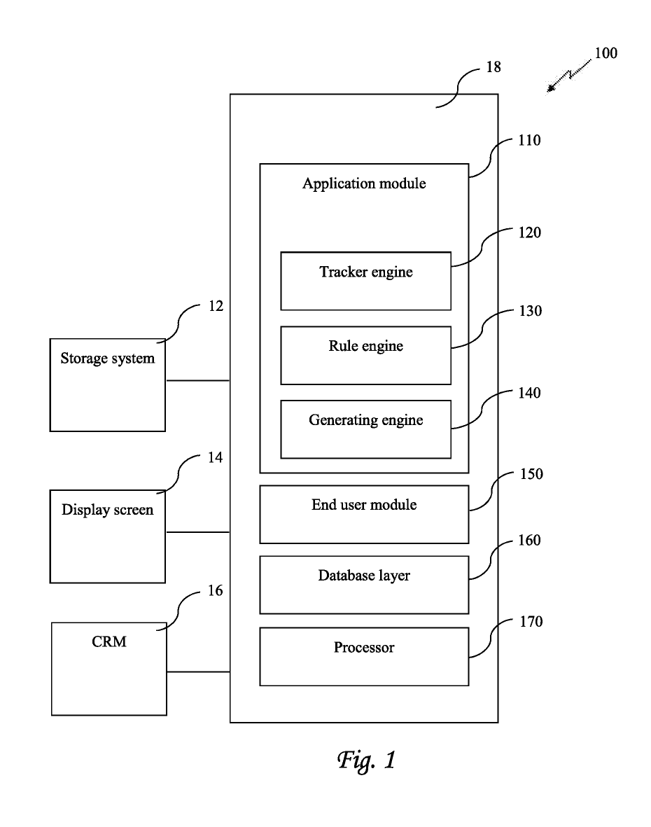

Reference is now made to FIG. 1 is a block diagram of one embodiment of a system to provide one or more gamification platforms to one or more users in an manufacturing line 100, said computing system comprising: a server 18 including a processor 170, memory/storage system 12 and computer readable media 16; an application module 110 communicably coupled to said server 18, configured to provide a unified and an integrated gamification functions in real time across one or more manufacturing line applications; an end user module 150 communicably coupled to said server, wherein said module comprises gamification data that an end user provides to or receives through a user interface; a database layer 160 communicably coupled to said server, and configured to manage and manipulate data in underlying database; and said application module further comprises: a tracker engine 120 configured to track one or more activities associated with manufacturing line performance of said one or more end users and communicate said one or more activities accomplished by said one or more users to a rule engine; and said rule engine 130 configured to define one or more unified parameters to correlate to said one or more activities across said one or more manufacturing line applications by said one or more users; and a generating engine 140 configured to generate gamification system framework comprising said unified parameters correlating to said one or more activities across said one or more manufacturing line applications of said one or more users.

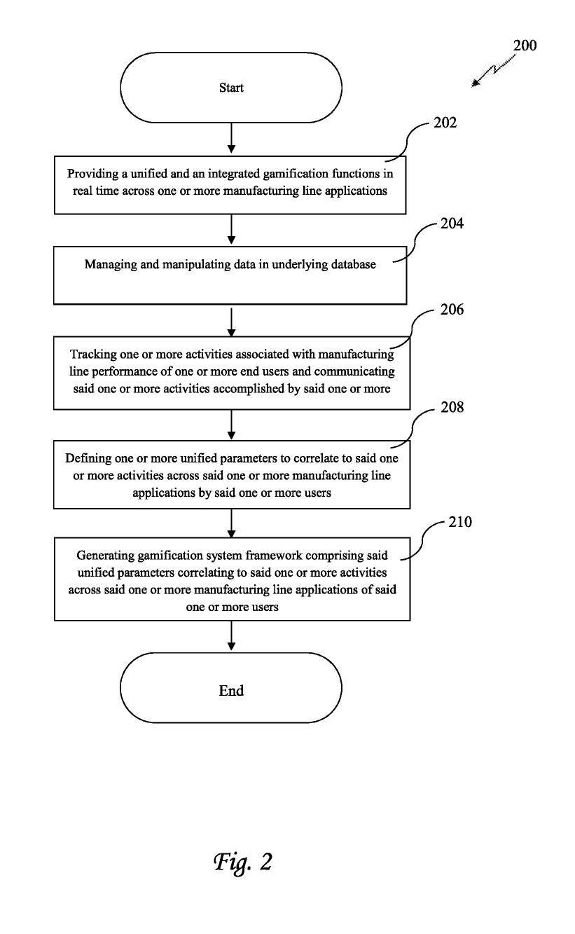

Reference is now made to FIG. 2, presenting a flow diagram illustrating a method to provide one or more gamification platforms to one or more users in a manufacturing line 200. Said method comprising, for a number of repetitions, steps of providing one or more gamification platforms to one or more users in an manufacturing line 100, the method comprising steps of: providing a unified and an integrated gamification functions in real time across one or more manufacturing line applications 202; managing and manipulating data in underlying database 204; tracking one or more activities associated with manufacturing line performance of one or more end users and communicating said one or more activities accomplished by said one or more users 206; defining one or more unified parameters to correlate to said one or more activities across said one or more manufacturing line applications by said one or more users 208; and generating gamification system framework comprising said unified parameters correlating to said one or more activities across said one or more manufacturing line applications of said one or more users 210.

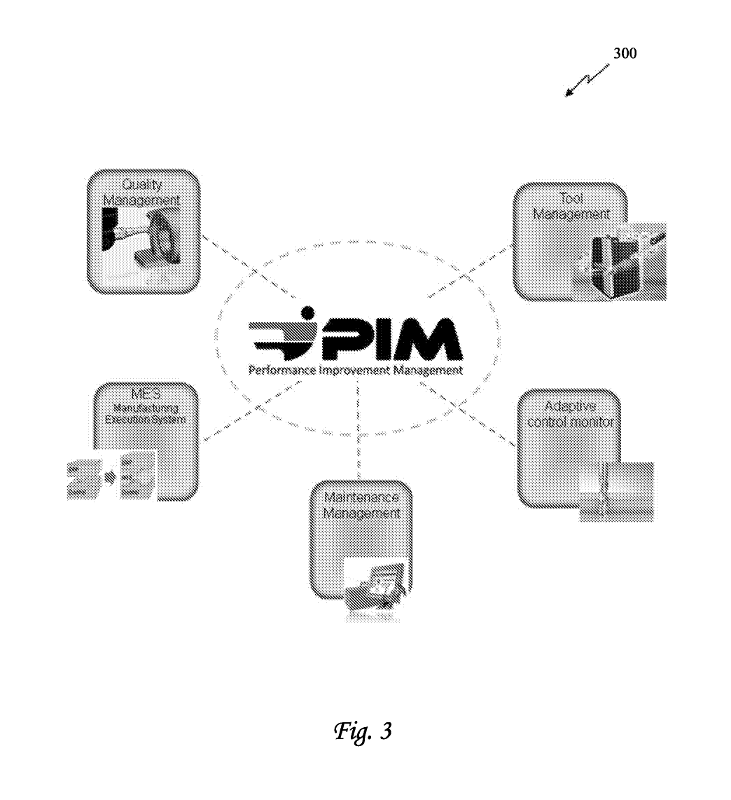

Reference is now made to FIG. 3, presenting the variety of systems that can be integrated and used as a source or as a client of gamification platforms to one or more users in a manufacturing line such as: tool-management, adaptive control monitor, maintenance management, manufacturing execution system and quality management.

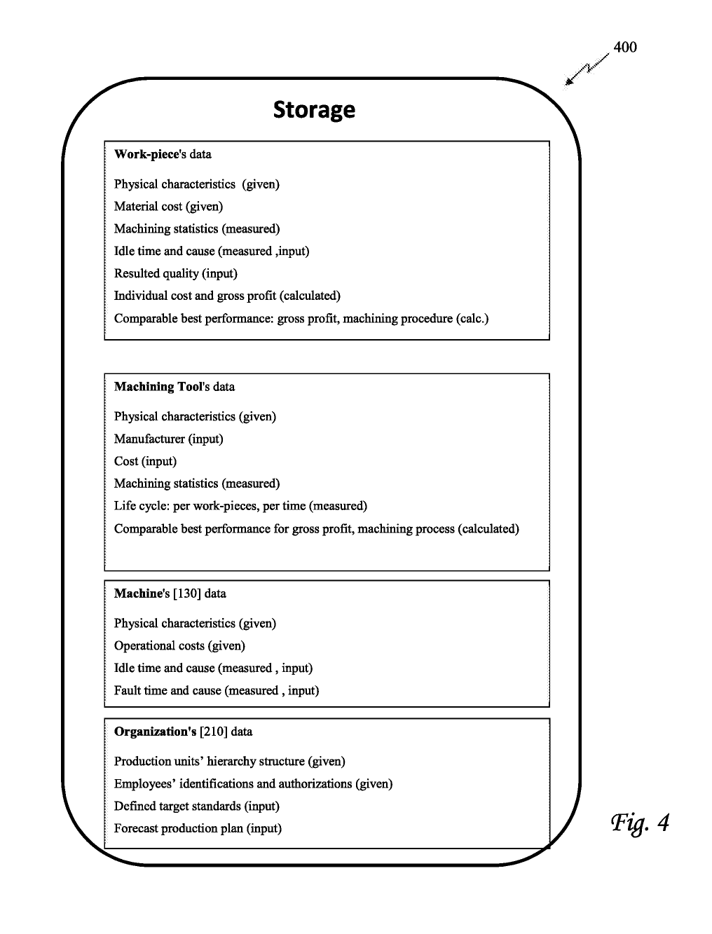

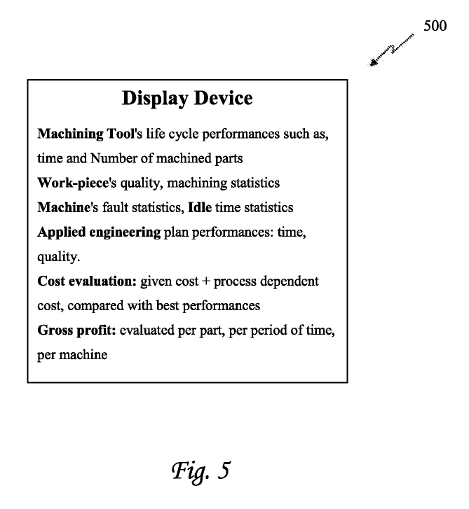

Reference is now made to FIG. 4, presenting a diagram describing the components of the storage including performance indicators 400: work-piece's data including: physical characteristics, which is a given data; material cost, which is a given data; machining statistics, which is a measured data; idle time which is a measured data; resulted quality which is an input data; individual engineering score, direct operations costs and gross profit, which are calculated data; and comparable best performance: engineering score, direct operations costs and gross profit, machining procedure which are calculated; machining consumable tool's data including: physical characteristics which is a given data; manufacturer which is a given data; cost which is an input data; machining statistics which is a measured data; life cycle: per work-pieces, per time which is a measured data; and comparable best performance for direct operations cost and gross profit which are calculated data. Machining production machine's data including: physical characteristics which is a given data; Operational costs which is a measured or input data; Exceptional long waiting idle time which is a measured data and it's cause which is an input data; Fault time which is a measured data and it's cause which is an input data. Organization data including: production units hierarchy structure, which is a given data; employees identifications and authorizations, which are given data; manual defined target standards, which are input data; forecast production plan, which is input data. Reference is now made to FIG. 5, presenting a diagram describing the system's output element displayed via the display means 500 including: Work-piece's quality, machining statistics, calibration statistics; machine's fault statistics; idle time statistics; applied engineering plan performances; machining consumable tool's life cycle performances such as, time and Number of machined parts; Cost evaluation: given cost and process dependent cost, compared with best performances; Efficiency evaluation: reflecting the different time unit elements influence on the quantity of work-piece's produced; Gross profit: evaluated per work-piece, per period of time, per machine. Said data can be used to benchmark data associated with a particular manufacturing line phase goal with one or more personal profiles associated with said one or more users.

What is claimed is:

1. A computer-implemented gamification system to provide one or more gamification platforms to one or more users in an manufacturing line, said gamification system comprising:
a. a server including a processor, memory and computer readable media;
b. an application module communicably coupled to said server, configured to provide a unified and an integrated gamification functions in real time across one or more manufacturing line applications;
c. an end user module communicably coupled to said server, wherein said module comprises gamification data that an end user provides to or receives through a user interface;
d. a database layer communicably coupled to said server, and configured to manage and manipulate data in underlying database; and
e. wherein said application module further comprises:
i. a tracker engine configured to track one or more activities associated with manufacturing line performance of said one or more end users and communicate said one or more activities accomplished by said one or more users to a rule engine; and
ii. said rule engine configured to define one or more unified parameters to correlate to said one or more activities across said one or more manufacturing line applications by said one or more users; and
iii. a generating engine configured to generate gamification system framework comprising said unified parameters correlating to said one or more activities across said one or more manufacturing line applications of said one or more users.

2. The computer-implemented gamification system of claim 1, wherein said gamification system framework is derived from analysis of said unified parameters based on real-time analytics and decision making output.

3. The computer-implemented gamification system of claim 1, wherein said gamification system is configured to classify one or more frameworks for accomplishing a particular manufacturing line phase goal.

4. The computer-implemented gamification system of claim 1, wherein said one or more frameworks for accomplishing a particular manufacturing line phase goal comprise one or more manufacturing line performance indicators.

5. The computer-implemented gamification system of claim 4, wherein said manufacturing line performance indicators selected from the group consisting of operations indicators such as but not limited to capacity utilization rate, hourly utilization rate, time usage efficiency, overall equipment efficiency, productivity, availability, quality, operating time, available time, work-piece's machining time, work-piece's idle time, work-piece's quantities, machine operational cost, machine working plan, machine fault time, machine fault cause, machine exceptional long waiting idle time, machine exceptional long waiting idle time cause, machine setup time, machine neutral time, machine disconnection time, machine planned down time, consumable tool's cost, consumable tool's wear-out characteristics, consumable tool's number of machined work-pieces until wear-out, and any combination thereof; engineering indicators such as but not limited to work-piece's individual engineering score, stock removal rate, specific stock removal energy, chip thickness ratio, cutting performance indicators, extracted from the velocities and working parameters of each cutting action of a work-piece, work-piece's cutting times, work-piece's non cutting times, work-piece's average spindle power, work-piece's number of cuts, work-piece's sub operations performances, and any combination thereof; financial indicators such as but not limited to unshaped work-piece's cost, shaped work-piece's selling price, consumable tools' relative costs, work-piece's individual direct operations costs, work-piece's, individual gross profit, and any combination thereof.

6. The computer-implemented gamification system of claim 1, wherein said application module is configured to generate one or more personal profiles associated with said one or more users, each profile including at least data associated with a particular manufacturing line phase goal.

7. The computer-implemented gamification system of claim 6, wherein said database layer is configurable to facilitate an access to said database comprising one or more personal profiles associated with said one or more users.

8. The computer-implemented gamification system of claim 1, wherein said end user module is configured to notify said one or more users of said data associated with a particular manufacturing line phase goal.

9. The computer-implemented gamification system of claim 1, wherein said application module is configured to benchmark said data associated with a particular manufacturing line phase goal with one or more personal profiles associated with said one or more users.

10. A computer-implemented gamification system to provide one or more gamification platforms to one or more users in an manufacturing line, said gamification system comprising:
a. means for providing a unified and an integrated gamification functions in real time across one or more manufacturing line applications;
b. means for managing and manipulating data in underlying database;
c. means for tracking one or more activities associated with manufacturing line performance of one or more end users and communicating said one or more activities accomplished by said one or more users;
d. means for defining one or more unified parameters to correlate to said one or more activities across said one or more manufacturing line applications by said one or more users; and
e. means for generating gamification system framework comprising said unified parameters correlating to said one or more activities across said one or more manufacturing line applications of said one or more users.

11. The computer-implemented gamification system of claim 10, wherein said gamification system further comprises means for classifying one or more frameworks for accomplishing a particular manufacturing line phase goal.

12. The computer-implemented gamification system of claim 10, wherein said gamification system further comprises means for generating one or more personal profiles associated with said one or more users, each profile including at least data associated with a particular manufacturing line phase goal.

13. The computer-implemented gamification system of claim 10, wherein said gamification system further comprises means for facilitating an access to said database comprising one or more personal profiles associated with said one or more users.

14. The computer-implemented gamification system of claim 10, wherein said gamification system further comprises means for notifying said one or more users of said data associated with a particular manufacturing line phase goal.

15. The computer-implemented gamification system of claim 10, wherein said gamification system further comprises means for benchmarking said data associated with a particular manufacturing line phase goal with one or more personal profiles associated with said one or more users.

16. A computer readable medium comprising a computer-implemented gamification system, wherein said system comprises logic for:
a. providing a unified and an integrated gamification functions in real time across one or more manufacturing line applications;
b. managing and manipulating data in underlying database;
c. tracking one or more activities associated with manufacturing line performance of one or more end users and communicating said one or more activities accomplished by said one or more users;
d. defining one or more unified parameters to correlate to said one or more activities across said one or more manufacturing line applications by said one or more users; and
e. generating gamification system framework comprising said unified parameters correlating to said one or more activities across said one or more manufacturing line applications of said one or more users.

17. The computer readable medium of claim 16, wherein said gamification system further comprises logic for classifying one or more frameworks for accomplishing a particular manufacturing line phase goal.

18. The computer readable medium of claim 16, wherein said gamification system further comprises logic for generating one or more personal profiles associated with said one or more users, each profile including at least data associated with a particular manufacturing line phase goal.

19. The computer readable medium of claim 16, wherein said gamification system further comprises logic for facilitating an access to said database comprising one or more personal profiles associated with said one or more users.

20. The computer readable medium of claim 16, wherein said gamification system further comprises logic for notifying said one or more users of said data associated with a particular manufacturing line phase goal.

21. The computer readable medium of claim 16, wherein said gamification system further comprises logic for benchmarking said data associated with a particular manufacturing line phase goal with one or more personal profiles associated with said one or more users.

22. A method in support of providing one or more gamification platforms to one or more users in a manufacturing line, performed by a server, the server being connected to a network and having a memory, a processor, and one or more code sets stored in the memory and executable in the processor, said method comprising:
a. providing a unified and an integrated gamification functions in real time across one or more manufacturing line applications;
b. managing and manipulating data in underlying database;
c. tracking one or more activities associated with manufacturing line performance of one or more end users and communicating said one or more activities accomplished by said one or more users;
d. defining one or more unified parameters to correlate to said one or more activities across said one or more manufacturing line applications by said one or more users; and
e. generating gamification system framework comprising said unified parameters correlating to said one or more activities across said one or more manufacturing line applications of said one or more users.

23. The method of claim 22, wherein said method further comprises a step for classifying one or more frameworks for accomplishing a particular manufacturing line phase goal.

24. The method of claim 22, wherein said method further comprises a step for generating one or more personal profiles associated with said one or more users, each profile including at least data associated with a particular manufacturing line phase goal.

25. The method of claim 22, wherein said method further comprises a step for facilitating an access to said database comprising one or more personal profiles associated with said one or more users.

26. The method of claim 22, wherein said method further comprises a step for notifying said one or more users of said data associated with a particular manufacturing line phase goal.

27. The method of claim 22, wherein said method further comprises a step for benchmarking said data associated with a particular manufacturing line phase goal with one or more personal profiles associated with said one or more users.
